(19) United States
(12) Patent Application Publication
(10) Pub. No.: US 2007/0204867 A1
(43) Pub. Date: Sep. 6, 2007

(54) Mouth moisturizing appliance

(76) Inventors: Earle J. Kennedy JR., St. Louis, MO (US); Earle J. Kennedy IV, Ballwin, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/364,913

(22) Filed: Mar. 1, 2006

(51) Int. Cl. A61C 5/14

(52) U.S. Cl. 128/859

(57) ABSTRACT

An apparatus for providing a controlled flow of liquid directly to a user's mouth to alleviate dry mouth conditions. The apparatus consists of a liquid reservoir, a mouthpiece, and a fluid passage between the liquid reservoir and mouthpiece through which liquid from the reservoir is delivered by gravity feed at a controlled rate by a flow control means to the mouthpiece for release into a user's mouth. The mouthpiece is an open sided unitary construction, sized to seat over either the user's upper or lower dentures. Liquid from the liquid reservoir is delivered by the fluid passage to one or more openings within the mouthpiece, and subsequently flows into the user's mouth.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention is related generally to an apparatus for maintaining moisture in the mouth of a patient, and in particular, to an apparatus for delivering a controlled flow of a moisturizing liquid to a user's mouth during sleep.

A dry mouth medical condition, known as “Xerostomia” affects about one in every four to five adults, mainly women, and becomes more prevalent with increased age. The dry mouth condition is usually due to a decrease in the amount of saliva present in the mouth.

Saliva assists in several different functions of the mouth. In addition to providing moisture to the mouth tissues, saliva facilitates speech, taste, chewing, swallowing, and digestion. Saliva further assists in the protection of the teeth, mouth, lips, and esophagus by preventing tooth decay and washing away food and plaque deposits. Minerals found in saliva assist in repairing damage caused by early tooth decay, and limit bacterial growth which may dissolve tooth enamel or lead to mouth infections. Any disruption in the amount or flow of saliva to the mouth may have serious and morbid consequences.

Drying of the mouth irritates the soft tissues, causing inflammation and susceptibility to infection. Without the cleansing effects of saliva, tooth decay and other oral health problems become more common. Patients using oral inhalers for asthma often develop oral candidiasis, and oral fungal infection, and are encouraged to rinse their mouths frequently with water after using an inhaler.

Hundreds of medications, including some over-the-counter drugs, produce dry mouth as a side effect. Among the more likely types to cause these problems are drugs used to tread depression and anxiety, antihistamines, high blood pressure medications, anti-diarrheals, muscle relaxants, drugs for urinary incontinence, and Parkinson's disease medications. In addition to medications, there are numerous diseases which affect the salivary glands. For example, incurable Sjogren's Syndrome, HIV/AIDS, diabetes, and Parkinson's disease can all cause dry mouth. Dry mouth may also result as a side effect from radiation therapy or chemotherapy used during cancer treatment.

When a patient is awake and aware of their condition, it is often a simple matter to regularly drink water or other liquids to relive dry mouth conditions. However, during sleep, or when a patient is unable to care for themselves, dry mouth conditions can become exacerbated. Accordingly, there is a need for an apparatus which can provide a controlled flow of liquid directly to a user's mouth to alleviate dry mouth conditions, without requiring any action on the part of the patient.

### BRIEF SUMMARY OF THE INVENTION

Briefly stated, the present invention provides an apparatus for providing a controlled flow of liquid directly to a user's mouth to alleviate dry mouth conditions. The apparatus consists of a liquid reservoir, a mouthpiece, and a fluid passage between the liquid reservoir and mouthpiece through which liquid from the reservoir is delivered by gravity feed at a controlled rate by a flow control means to the mouthpiece for release into a user's mouth. The mouthpiece is an open sided unitary construction, sized to seat over either the user's upper or lower dentures. Liquid from the liquid reservoir is delivered by the fluid passage to one or more openings within the mouthpiece, and subsequently flows into the user's mouth.

The foregoing features, and advantages of the invention, as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 illustrates an embodiment of the mouth moisturizing apparatus of the present invention configured for normal usage;

FIG. 2 illustrates a rear perspective view of a mouthpiece component of the mouth moisturizing apparatus of FIG. 1;

FIG. 3 is a rear perspective view of the mouthpiece of FIG. 2 in use over a user's lower denture;

FIG. 4 is a midline sectional view of the mouthpiece of FIG. 2 in use over a user's lower denture; and

FIG. 5 is a front view illustration of the mouthpiece of FIG. 2 in use over a user's lower denture.

Corresponding reference numerals indicate corresponding parts throughout the several figures of the drawings. It is to be understood that the drawings are for illustrating the concepts of the invention and are not to scale.

### DESCRIPTION OF THE PREFERRED EMBODIMENT

The following detailed description illustrates the invention by way of example and not by way of limitation. The description enables one skilled in the art to make and use the invention, and describes several embodiments, adaptations, variations, alternatives, and uses of the invention, including what is presently believed to be the best mode of carrying out the invention.

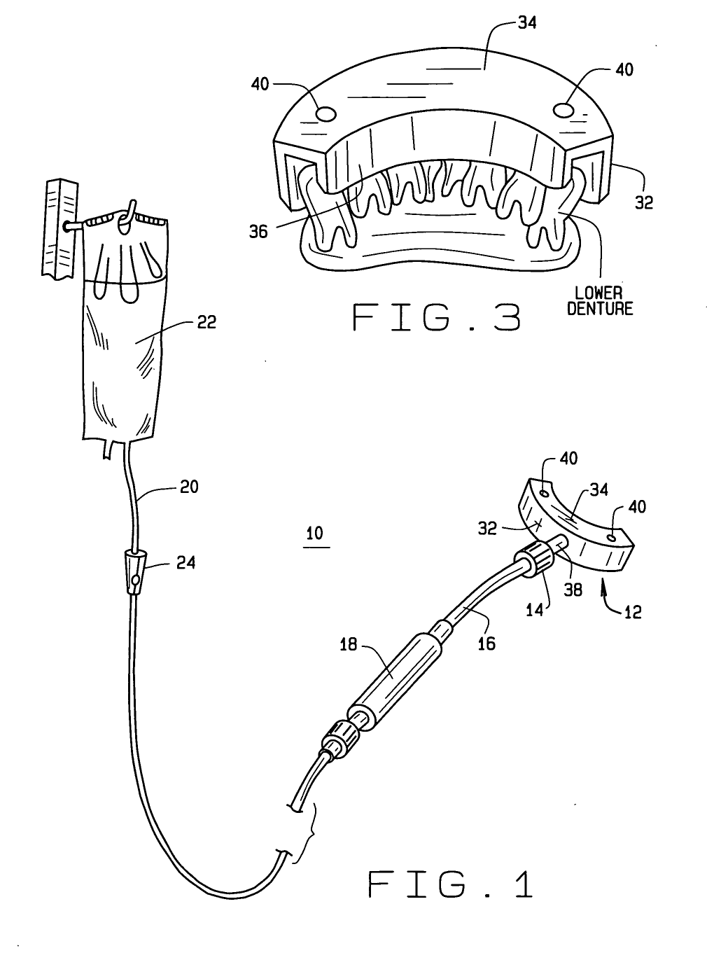

Turning to FIG. 1, an apparatus of the present invention is illustrated generally at 10. A mouthpiece 12 is secured through a connector 14 to a first stage tube 16 to a optional backflow prevention valve 18, and then on through a second stage tube 20 to a fluid reservoir 22. The first and second stage tubes are preferably formed from a flexible plastic material such as used in association with drip sets or other equipment for the supply of fluids to a patient. The fluid reservoir 22 is similarly of a conventional construction, and may comprise either a sealable plastic bag or a rigid fluid container. A flow control means 24, such as a tube clamp or valve, is disposed on the second stage tube 20 to regulate the flow of fluid from the fluid reservoir 22 to the mouthpiece 12.

Those of ordinary skill in the art will recognize that the components illustrated in FIG. 1 for delivering a supply of liquid to the mouthpiece 12, i.e. the first and second stage tubes 16, 20, the backflow prevention valve 18, and the flow control means 24 may consist of any of a variety of available components, sized and configured as selected to deliver a supply of liquid from the fluid reservoir 22 to the mouthpiece 12 at a desired rate of flow. The flow of liquid is preferably gravity feed, but may be delivered via a capillary action or pumping force without departing from the scope of the invention.

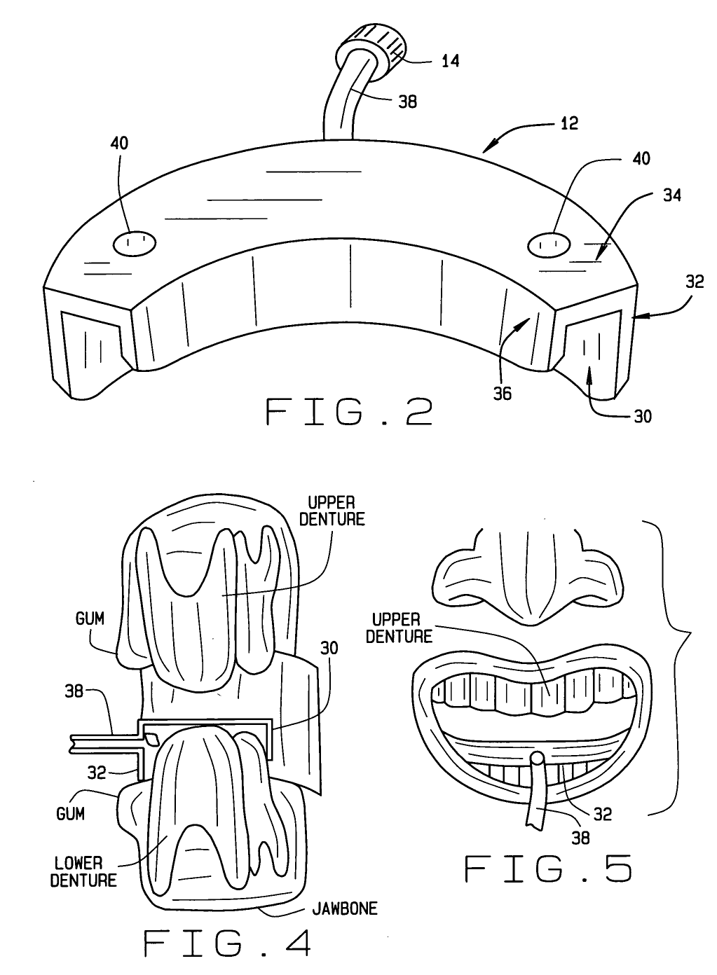

Turning to FIG. 2, the mouthpiece 12 is shown in a rear perspective view. Generally sized to fit over a portion of either the upper or lower dentures of an adult human patient, the mouthpiece defines an arcuate channel 30 enclosed on three sides by a front face 32, a cross member 34, and a back face 36. A coupling tube 38 secures the mouthpiece 12 to the connector 14, facilitating disconnection from the reservoir 22 and supply components. The coupling tube 38 passes through the front face 32 of the mouthpiece 12, and opens into the arcuate channel 30. A plurality of ports 40 are optionally disposed about the various surfaces 32, 34, and 36 of the mouthpiece 12, providing for fluid flow passages between the arcuate channel 30 and the user's mouth.

As can be seen in FIG. 2, preferably the front face 32 which defines a portion of the arcuate channel 30, extends further from the cross member 34 than does the back face 36, thereby accommodating the anatomy of a user's mouth and enabling the mouthpiece 12 to securely seat over a user's dentures. As used herein, the term dentures is intended to interchangeable describe a user's natural teeth, artificial teeth, or gums (in the case of missing teeth). Those of ordinary skill in the art will recognize that the mouthpiece 12 may be constructed from a variety of suitable materials, and may have a variety of sizes to accommodate the individual characteristics of different patients. Optionally, the mouthpiece 12 may be manufactured from a suitable dental plastic using a mold a user's upper or lower dentures, providing a customized fit.

Alternatively, the mouthpiece 12 may be formed from a pliable material, enabling a limited range of adjustment to accommodate different sizes and shapes of dentures.

Use of the mouth moisturizing apparatus 10 of the present invention is described in connection with FIG. 3 through FIG. 5. The mouthpiece 12 is placed in a user's mouth, either over the upper frontal dentures, or as illustrated in FIG. 3, over the lower frontal dentures. The mouthpiece 12 is preferably maintained in place by closure of the user's mouth and jaw. The connector 14 is coupled to the first tube 16, and the flow control means 24 adjusted to enable a fluid flow rate from the liquid reservoir 22 at a desired rate to provide sufficient mouth moisture, for example, a rate of one to two drips per minute. The fluid flows through the tubes 20 and 16, and into the coupling tube 38, where it subsequently entered the arcuate channel 30, as best seen in FIG. 4. The fluid seeps from the arcuate channel 30 past the dentures, or alternately, exits through the various ports 40, into the user's mouth to stimulate the salivary glands and to provide mouth moisture.

Those of ordinary skill in the art will recognize that the fluid flow may be either a gravity feed, or may be a pressured fluid flow. Furthermore, the connector 14 enable the liquid reservoir 22 to be disconnected and replaced without removing the mouthpiece 12 from the user's mouth. In this manner, an empty liquid reservoir 22 may be easily changed without awaking a sleeping patient.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A mouth moisturizing appliance comprising:
a mouthpiece adapted for placement over a portion of a wearer's dentures;
a liquid reservoir operatively coupled to said mouthpiece via a fluid flow connection to effect delivery of a controlled flow of liquid from said liquid reservoir to said mouthpiece; and
wherein said mouthpiece defines an arcuate channel into which said flow of liquid from said liquid reservoir is delivered.

2. The mouth moisturizing appliance of claim 1 where said fluid flow connection further includes at least one length of flexible tubing coupled between said liquid reservoir and said mouthpiece;
a flow control means associated with said at least one length of flexible tubing to regulate a flow of liquid through said flexible tubing; and
a connector for removably coupling said at least one length of flexible tubing to said mouthpiece.

3. The mouth moisturizing appliance of claim 2 wherein said fluid flow connection further includes a back flow prevention valve operatively coupled to said flexible tubing between said liquid reservoir and said mouthpiece.

4. The mouth moisturizing appliance of claim 1 wherein said mouthpiece includes a front face, a rear face, and a cross member coupling said front face to said rear face; and
wherein said front face, said rear face, and said cross member define said arcuate channel.

5. The mouth moisturizing appliance of claim 4 further including a coupling disposed in said front face for receiving said fluid flow connection, said coupling passing through said front face and having an open termination within said arcuate channel for delivery of a liquid from said fluid flow connection to said arcuate channel.

6. The mouth moisturizing appliance of claim 4 further including a plurality of fluid flow ports passing through said cross member to facilitate a flow of fluid from within said arcuate channel.

7. The mouth moisturizing appliance of claim 4 wherein said mouthpiece is of a unitary construction.

8. The mouth moisturizing appliance of claim 4 wherein said mouthpiece is formed from a pliable material to conform to a wearer's dentures.

9. The mouth moisturizing appliance of claim 4 wherein said mouthpiece is formed from a rigid material conforming to a wearer's dentures.

10. A method for delivering a flow of liquid to a wearer's mouth using the mouth moisturizing appliance of claim 1, comprising:
disposing the mouthpiece within the wearer's mouth, over the wearer's dentures;
coupling said mouthpiece to said liquid reservoir via said fluid flow connection; and
selecting a fluid delivery rate for a flow of liquid from said liquid reservoir to said mouthpiece.

11. The method of claim 10 wherein said flow of liquid is gravity fed.

12. The method of claim 10 wherein said mouthpiece is disposed over a frontal section of a wearer's lower dentures.

13. The method of claim 10 wherein said mouthpiece is disposed over a frontal section of a wearer's upper dentures.
